(19) United States
(12) Patent Application Publication
(10) Pub. No.: US 2007/0121618 A1
(43) Pub. Date: May 31, 2007

(54) Method and system for priority based routing

(76) Inventor: Asao Hirano, Yokohama-shi (JP)

Correspondence Address: MOTOROLA INC, 600 NORTH US HIGHWAY 45, ROOM AS437, LIBERTYVILLE, IL, 60048-5343, US

(21) Appl. No.: 11/289,841

(22) Filed: Nov. 30, 2005

(51) Int. Cl. H04L 12/56; H04L 12/28; G06F 15/173; H04Q 7/24; H04J 1/16

(52) U.S. Cl. 370/389; 709/240; 370/338; 370/235

(57) ABSTRACT

A method and system for routing a data packet, intended for a destination node, from a source node to a first intermediate node in a network is useful for improving network efficiency and participation. The method includes determining a priority level of the source node and a priority level of the first intermediate node (step 505). A routing path is then selected that routes the data packet from the source node to the first intermediate node based on a comparison of the priority level of the source node and the priority level of the first intermediate node (step 515). The priority level of the source node is determined in part by a number of previous data packets that were routed through the source node, and the priority level of the first intermediate node is determined in part by a number of previous data packets that were routed through the first intermediate node.

### FIELD OF THE INVENTION

The present invention relates generally to priority based data routing in ad hoc and mesh network communications systems.

### BACKGROUND

Many wireless communications systems require a rapid deployment of independent mobile users as well as reliable communications between the users. Mobile Ad Hoc Networks (MANETs) are based on autonomous collections of mobile users who communicate with each other over wireless links having limited bandwidths. MANETs are usually temporary packet radio networks which do not involve significant supporting structure and in which the user nodes themselves perform routing functions.

MANETs provide critical communication services in various environments involving, for example, emergency services supporting police and fire personnel, military applications, industrial facilities and construction sites. Routing communications between two nodes in a static network generally involves simply determining the shortest route between the two nodes. However, in a MANET, the determination of an optimal communication route may involve many additional factors. For example, propagation path losses, interference between users, and channel fading may require the use of an indirect route between two nodes in order to provide an acceptable Quality of Service (QoS) to the network users.

Because MANETs generally do not comprise significant supporting structure, such as fixed base stations, but rely on user nodes to act as relay or intermediate nodes, participation in a MANET by a high number of users is often critical. For example, if a MANET covers a significant area that is wider than the transmission range of any single user node, a transmission across the full width of the MANET will require “hopping” through at least one intermediate user node. Unless an adequate number of such intermediate user nodes participate in the network—and enable transmissions addressed to other nodes to be routed through the intermediate user nodes—then the network breaks down and at least some transmissions cannot be completed.

A mesh network is a type of MANET where every node is wirelessly connected, either directly or indirectly, to every other node in the network. Similar to the operation of routers on the Internet, in a mesh network if one intermediate node is not available a data packet can simply be routed through an alternative intermediate node. Mesh networks thus can be highly reliable, adaptable and scalable. However, as with MANETs generally, high user participation rates are also very important in mesh networks. As more user nodes participate in a mesh network, the average distance between nodes decreases, and reliability and link quality increases.

### SUMMARY OF THE INVENTION

According to one aspect, the invention is a method for routing a data packet, intended for a destination node, from a source node to a first intermediate node in a network. The method includes determining a priority level of the source node and a priority level of the first intermediate node. A routing path is then selected that routes the data packet from the source node to the first intermediate node based on a comparison of the priority level of the source node and the priority level of the first intermediate node. The priority level of the source node is determined in part by a number of previous data packets that were routed through the source node, and the priority level of the first intermediate node is determined in part by a number of previous data packets that were routed through the first intermediate node.

According to another aspect, the invention is a system for routing a data packet, intended for a destination node, from a source node to a first intermediate node in a network. The system includes computer readable program code components configured to determine a priority level of the source node and a priority level of the first intermediate node. Also, computer readable program code components are configured to select a routing path that routes the data packet from the source node to the first intermediate node based on a comparison of the priority level of the source node and the priority level of the first intermediate node. The priority level of the source node is determined in part by a number of previous data packets that were routed through the source node, and the priority level of the first intermediate node is determined in part by a number of previous data packets that were routed through the first intermediate node.

Thus, according to particular embodiments of the present invention, users who participate frequently in a network are granted priority privileges, resulting in a higher individual Quality of Service (QoS) over users who participate less frequently. That in turn encourages higher overall participation in the network, which decreases average distances between network nodes and increases overall network QoS.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram of a communication network comprising a plurality of communication nodes, according to an embodiment of the present invention.

FIG. 2 is a flow diagram that describes a routing path selection method for routing a data packet through a network, according to an embodiment of the present invention.

FIG. 3 is a flow diagram that continues the description of the routing path selection method shown in FIG. 2 for routing a data packet through a network, according to an embodiment of the present invention.

FIG. 4 is a flow diagram that continues the description of the routing path selection method shown in FIG. 3 for routing a data packet through a network, according to an embodiment of the present invention.

FIG. 5 is a general flow diagram illustrating a method for routing a data packet, intended for a destination node, from a source node to a first intermediate node in a network, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and system for priority based routing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

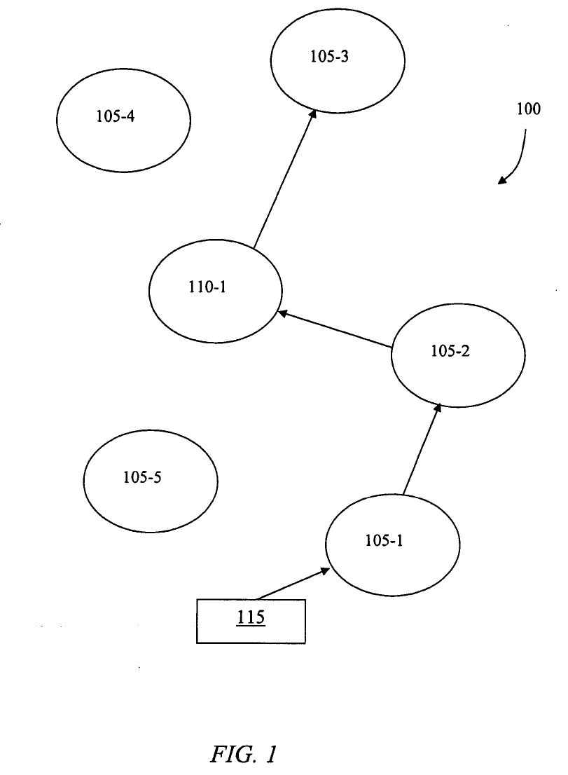

Referring to FIG. 1, there is a schematic diagram of a communication network 100 comprising a plurality of private communication nodes 105-n according to an embodiment of the present invention. The network 100 can be, for example, a wireless Mobile Ad Hoc Network (MANET), and the private nodes 105-n can be associated with devices such as mobile phones or handheld radios. Also, the network 100 can include public nodes 110-n associated with devices such as routers that are installed in fixed locations. For example a public node 110-1 can comprise a wireless local area network (WLAN) access point (AP) positioned on a light pole in a city. As described in more detail below, a data packet 115 is routed through the network 100 based on priority levels that are assigned to both the packet itself and to the various nodes 105-n, 110-n through which the packet 115 can be routed.

The priority level assigned to a data packet 115 is determined in part by a number of previous data packets that were routed through a source node 105-n that transmits the packet 115. For example, each time a node 105-2 acts as an intermediate node 105-2 for routing a data packet 115 (such as when a data packet 115 is routed from a source node 105-1, through the intermediate node 105-2, to a destination node 105-3), a priority level associated with the node 105-2 will be incremented. Then, when the node 105-2 acts as a source node 105-2, and seeks to transmit its own data packet 115 to a destination node 105-n, that data packet 115 will receive a priority level that is determined in part by the number previous data packets 115 that were routed through the node-105-2. Thus the present invention encourages increased user participation in MANETs and mesh networks. User nodes 105-n that participate frequently as intermediate nodes 105-n in a network 100 will achieve priority access over other nodes 105-n, 110-n. Such priority access privileges enable users to obtain a higher Quality of Service (QoS) associated with their network use.

A priority level of a node 105-n, 110-n can be defined in various ways including as a multi-dimensional variable. Particular dimensions of such variables can then include, for example, a number of previous packets routed through a node 105-n, 110-n, a battery power attribute associated with a node 105-n, 110-n, a public/private attribute associated with a node 105-n, 110-n, or other dimensions that impact on the appropriateness of using a particular node 105-n, 110-n as an intermediate node 105-n, 110-n for routing data packets 115.

According to one embodiment of the present invention, the source node 105-1 assesses potential intermediate candidate nodes 105-n, 110-n by sending out a routing request message (RREQ) to all nodes 105-n, 110-n on a candidate list associated with the source node 105-1. The candidate list can be created in various ways including using Global Positioning System (GPS) searches or received signal strengths indicators (RSSIs). Each intermediate node 105-n, 110-n, such as node 105-2, that receives the RREQ then replies with a routing reply message (RREP) that includes various attributes, flags, or variables that are related to the present fitness of the intermediate node 105-2 to route a data packet 115. For example, such variables may include the IP address of the intermediate node 105-n, 110-n that originated the RREP, a low battery indicator, whether the intermediate node 105-n, 110-n is a public node 110-n, the number of previous data packets 115 that the intermediate node 105-n, 110-n has routed through it, a “hop count” totaling the number of hops from the source node 105-1 to a destination node 105-3 using the intermediate node 105-n, 110-n, and the time in milliseconds that the intermediate node 105-n, 110-n considers the RREP to be valid.

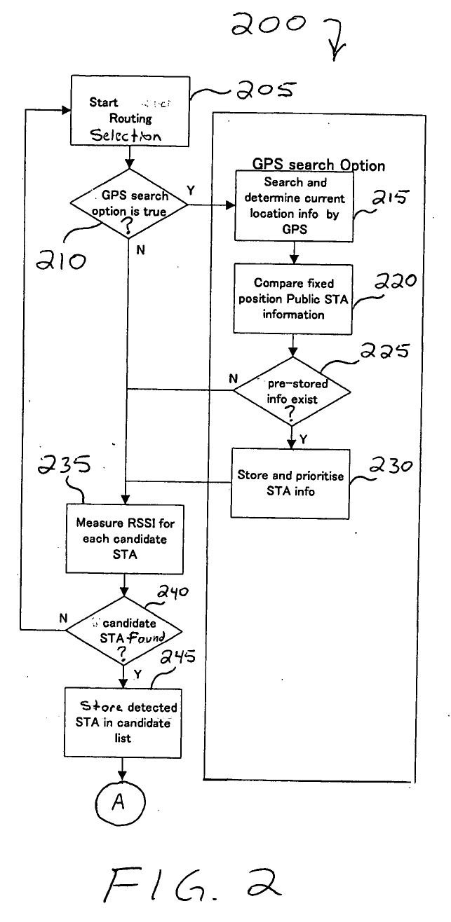

Referring to FIG. 2, a flow diagram is illustrated that describes a routing path selection method 200 for routing a data packet 115 through a network 100, according to an embodiment of the present invention. First, at step 205, the selection method 200 is started when a source node 105-n determines that it must transmit a packet 115 through the network 100 by identifying candidate intermediate nodes 105-n, 110-n, also referred to as stations (STAs). At step 210 it is determined whether a Global Positioning System (GPS) search option is available. As known to those skilled in the art, such a GPS search option enables the source node 105-n to identify the precise location of other nodes 105-n, 110-n in the network 100. If the GPS search option is available, at step 215 the current location of other nodes 105-n, 110-n in the network is determined. At step 220 the determined locations of the other private nodes 105-n in the network are compared with the locations of the public nodes 110-n in the network. Then at step 225 it is determined whether pre-stored information exists concerning private nodes 105-n or public nodes 110-n in the network. If pre-stored information exists then it is updated at step 230 and any new information concerning the identified private nodes 105-n or public nodes 110-n is stored and prioritized.

If a GPS search option is not available, or if no pre-stored information exists, or after the pre-stored information is prioritized, the method 200 continues at step 235 where an RSSI for candidate nodes 105-n, 110-n is measured. At step 240, if no candidate node 105-n, 110-n is identified then the method 200 cycles back to step 205. Otherwise, at step 245, detected candidate nodes 105-n, 110-n are stored in a candidate list.

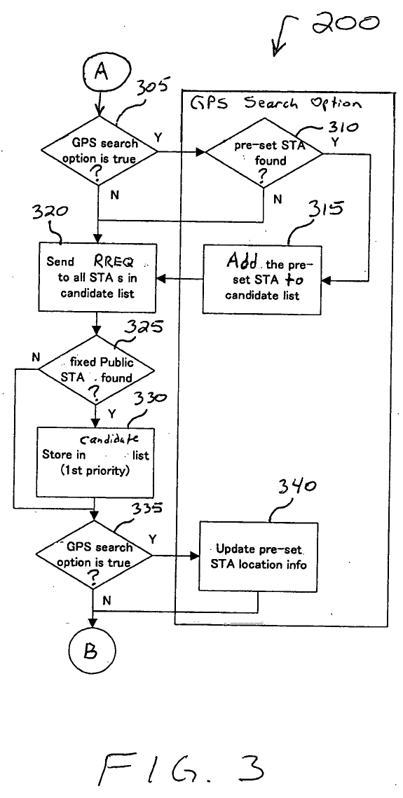

Referring to FIG. 3, a flow diagram is illustrated that continues the description of the routing path selection method 200 for routing a data packet 115 through a network 100, according to an embodiment of the present invention. Following step 245 from FIG. 2, at step 305 it is again determined whether a GPS search option is available. If so, at step 310 it is determined whether any pre-set nodes 105-n, 110-n have been identified. If so, at step 315 the pre-set nodes 105-n, 110-n are added to the candidate list. If a GPS search option is not available, or if no pre-set nodes 105-n, 110-n are found, or after the pre-set nodes 105-n, 110-n are added to the candidate list, the method 200 continues at step 320 where a RREQ is transmitted to all nodes 105-n, 110-n in the candidate list. At step 325 it is determined whether any candidate public nodes 110-n responded to the RREQ. If so, then at step 330 the candidate public nodes 110-n are stored in the candidate list. If no public nodes 110-n are found at step 325, or after the candidate public nodes 110-n are stored in the candidate list at step 330, at step 335 it is again determined whether a GPS search option is available. If so then at step 340 location information for the pre-set nodes 105-n, 110-n is updated.

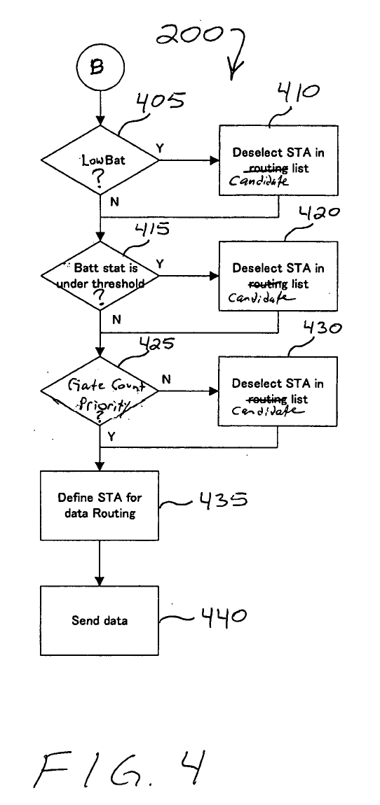

Referring to FIG. 4, a flow diagram is illustrated that again continues the description of the routing path selection method 200 for routing a data packet 115 through a network 100, according to an embodiment of the present invention. Following step 335 or step 340 from FIG. 3, at step 405 it is determined, for each candidate node 105-n, 110-n that is included in the candidate list, whether a low battery condition exists. If so, at step 410 each candidate node 105-n, 110-n with a low battery condition is deselected from the candidate list. Next, at step 415, it is determined, again for each candidate node 105-n, 110-n that is included in the candidate list, whether a battery status of a candidate node 105-n, 110-n is below a given threshold value. If so, then at step 420 each candidate node 105-n, 110-n with a battery status below the threshold is deselected from the candidate list.

Next, at step 425, it is determined whether a “gate count” associated with each candidate node 105-n, 110-n is higher than a “gate count” associated with the source node 105-n. If so, then permission to use a candidate node 105-n, 110-n as an intermediate node 105-n, 110-n is denied, and at step 430, each candidate node 105-n, 110-n having a gate count higher than the gate count of the source node is deselected from the candidate list.

A gate count, according to an embodiment of the present invention, is a measurement of the previous number of data packets 115 that have been routed through a particular node 105-n. For example, a gate count can be a simple integer value that is incremented by one each time a node 105-n acts as an intermediate node 105-n and transmits a data packet 115 that originated elsewhere in the network 100. Note that a gate count is generally not applicable to a public node 10-n, because the purpose of recording a gate count is to encourage network participation by users of private nodes 105-n.

The method 200 continues at step 435 where a particular node 105-n, 110-n is selected to act as an intermediate node 105-n, 110-n and receive a data packet 115. Finally, at step 440, a particular data packet 115 is transmitted. Thus, according to the method 200, users that participate frequently in a network 100 are rewarded, when they transmit their own data, by generally having a significantly larger number of candidate nodes 105-n, 110-n in a candidate list. That means that it is more likely that intermediate nodes 105-n, 110-n associated with higher quality communication links can be selected from the candidate list, resulting in a higher network QoS for frequently participating users.

Therefore, according to an embodiment of the present invention, gate counts and other node attributes are used to determine priority levels that are assigned to both source nodes 105-n, 110-n and intermediate nodes 105-n, 110-n in a network 100. For example, a priority level may be based on gate counts, whether a node 105-n, 110-n is connected to a stable power supply or to a battery, or an amount of available battery power remaining at a node 105-n, 110-n. Also, a public attribute can be used to identify public nodes 110-n and assign the public nodes 110-n a relatively high priority level. Thus packets 115 will be, wherever possible, routed through available public nodes 110-n rather than through available private nodes 105-n.

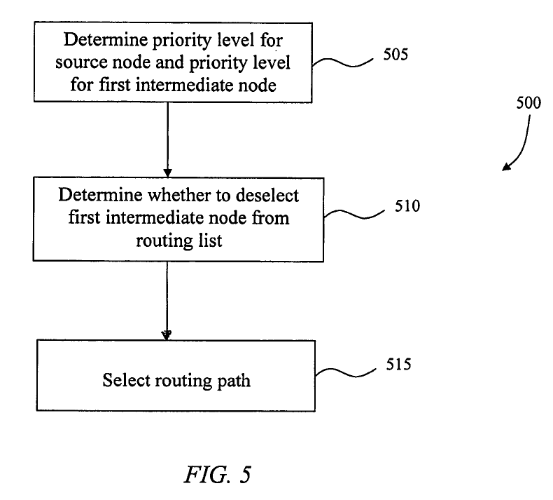

Referring to FIG. 5, a general flow diagram is illustrated of a method 500 for routing a data packet 115, intended for a destination node 105-3, from a source node 105-1 to a first intermediate node 105-2 in a network 100, according to an embodiment of the present invention. At step 505, a priority level is determined for the source node 105-1 and a priority level is determined for the first intermediate node 105-2. At step 510, it is determined whether to deselect the first intermediate node 105-2 from a routing list based on the priority level of the first intermediate node 105-2. At step 515, a routing path is selected that routes the data packet from the source node 105-1 to the first intermediate node 105-2 based on a comparison of the priority level of the source node 105-1 and the priority level of the first intermediate node 105-2. The priority level of the source node 105-1 is determined in part by a number of previous data packets that were routed through the source node 105-1; and the priority level of the first intermediate node 105-2 is determined in part by a number of previous data packets that were routed through the first intermediate node 105-2.

Those skilled in the art will recognize that the present invention can be embodied in a wireless electronic device, such as a device associated with a source node 105-n. The device can be, for example, a mobile phone, handheld radio device, personal digital assistant (PDA), or notebook computer. The device can include a standard microprocessor operatively connected to a computer readable medium such as a random access memory (e.g., static random access memory (SRAM)), read only memory (e.g., programmable read only memory (PROM) or electrically erasable programmable read only memory (EPROM)), or hybrid memory (e.g., FLASH memory) as is well known in the art. The medium then comprises computer readable program code components that, when processed by the microprocessor, are configured to execute the above described steps of the method 500.

Advantages of embodiments of the present invention thus include improved, more efficient, and fairer routing of data packets 115 through a network 100. Users who participate frequently in a network 100 are granted priority privileges, resulting in a higher individual QoS, over users who participate less frequently. That in turn encourages higher overall participation in a network 100, which decreases average distances between network nodes 105-n, 110-n and increases overall network QoS.

It will be appreciated that embodiments of the invention described herein may be comprised of one or more conventional processors and unique stored program instructions that control the one or more processors to implement, in conjunction with certain non-processor circuits, some, most, or all of the functions of priority based routing as described herein. The non-processor circuits may include, but are not limited to, a radio receiver, a radio transmitter, signal drivers, clock circuits, power source circuits, and user input devices. As such, these functions may be interpreted as steps of a method for priority based routing. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for routing a data packet, intended for a destination node, from a source node to a first intermediate node in a network, the method comprising:
determining a priority level of the source node and a priority level of the first intermediate node; and
selecting a routing path that routes the data packet from the source node to the first intermediate node based on a comparison of the priority level of the source node and the priority level of the first intermediate node, wherein the priority level of the source node is determined in part by a number of previous data packets that were routed through the source node, and the priority level of the first intermediate node is determined in part by a number of previous data packets that were routed through the first intermediate node.

2. The method of claim 1 wherein the priority level of the intermediate node is determined also in part by a power supply attribute of the intermediate node.

3. The method of claim 1 wherein the priority level of the intermediate node is determined also in part by a public attribute of the intermediate node.

4. The method of claim 1 wherein the source, destination and intermediate nodes comprise components of a mobile ad hoc network.

5. The method of claim 1 wherein the source, destination and intermediate nodes comprise components of a mesh network.

6. The method of claim 1 further comprising determining whether to deselect the first intermediate node from a routing list based on the priority level of the first intermediate node.

7. The method of claim 1, wherein the number of previous data packets that were routed through a particular node is measured by a gate count that is incremented each time a data packet is routed through the particular node.

8. The method of claim 1, wherein the priority level of a node is a multidimensional variable including dimensions selected from the group consisting of: a gate count, a power supply attribute, and a public attribute.

9. The method of claim 1, wherein the priority level of the first intermediate node is determined using a received routing reply message.

10. A system for routing a data packet, intended for a destination node, from a source node to a first intermediate node in a network, comprising:
computer readable program code components configured to determine a priority level of the source node and a priority level of the first intermediate node; and
computer readable program code components configured to select a routing path that routes the data packet from the source node to the first intermediate node based on a comparison of the priority level of the source node and the priority level of the first intermediate node, wherein the priority level of the source node is determined in part by a number of previous data packets that were routed through the source node, and the priority level of the first intermediate node is determined in part by a number of previous data packets that were routed through the first intermediate node.

11. The system of claim 10 wherein the priority level of the intermediate node is determined also in part by a power supply attribute of the intermediate node.

12. The system of claim 10 wherein the priority level of the intermediate node is determined also in part by a public attribute of the intermediate node.

13. The system of claim 10 wherein the source, destination and intermediate nodes comprise components of a mobile ad hoc network.

14. The system of claim 10 wherein the source, destination and intermediate nodes comprise components of a mesh network.

15. The system of claim 10 further comprising computer readable program code components configured to determine whether to deselect the first intermediate node from a routing list based on the priority level of the first intermediate node.

16. The system of claim 10, wherein the number of previous data packets that were routed through a particular node is measured by a gate count that is incremented each time a data packet is routed through the particular node.

17. The system of claim 10, wherein the priority level of a node is a multidimensional variable including dimensions selected from the group consisting of: a gate count, a power supply attribute, and a public attribute.

18. The system of claim 10, wherein the priority level of the fist intermediate node is determined using a received routing reply message.

19. A system for routing a data packet, intended for a destination node, from a source node to a first intermediate node in a network, comprising:
means for determining a priority level of the source node and a priority level of the first intermediate node; and
means for selecting a routing path that routes the data packet from the source node to the first intermediate node based on a comparison of the priority level of the source node and the priority level of the first intermediate node, wherein the priority level of the source node is determined in part by a number of previous data packets that were routed through the source node, and the priority level of the first intermediate node is determined in part by a number of previous data packets that were routed through the first intermediate node.
